(19) United States
(12) Patent Application Publication
(10) Pub. No.: US 2017/0314670 A1
(43) Pub. Date: Nov. 2, 2017

(54) Hydraulic Supply Arrangement and Control Method

(71) Applicant: ZF Friedrichshafen AG, Friedrichshafen (DE)

(72) Inventors: Adriano Handrich, Friedrichshafen (DE); Rolf Braun, Kressbronn (DE); Tim Rose, Oberried (DE); Thilo Schmidt, Meckenbeuren (DE); Peter Schiele, Kressbronn (DE); Florian Mayer, Wangen (DE)

(21) Appl. No.: 15/531,843

(22) PCT Filed: Nov. 2, 2015
(86) PCT No.: PCT/EP2015/075466

§ 371 Date: May 31, 2017

(30) Foreign Application Priority Data
Dec. 4, 2014 (DE) 10 2014 224 820.5

(51) Int. Cl. F16H 57/04

(52) U.S. Cl. CPC F16H 57/0435; F16H 57/0436

(57) ABSTRACT

Proposed is a hydraulic supply system in an automatic transmission of a vehicle, said hydraulic supply system having a primary hydraulic circuit (I) for supplying the transmission components, having a secondary hydraulic circuit (II) for lubricating and cooling the transmission components and having at least one pump (P) for generating a supply flow rate in the hydraulic circuits (I, II), wherein a detecting device (E) for detecting the current hydraulic fluid volumetric flow rate in the secondary hydraulic circuit (II) for adjusting a minimum supply flow rate of the pump (P) is provided. Furthermore, a method for controlling a pump of a hydraulic supply system in an automatic transmission of a vehicle is proposed, wherein the respectively current hydraulic fluid volumetric flow rate in a secondary hydraulic circuit (II) for lubricating and cooling the transmission components is detected, wherein a volumetric flow rate requirement is determined from a characteristic map relating to the current operating range of the automatic transmission, and wherein the supply flow rate of the pump (P) is controlled as a function of the determined volumetric flow rate requirement.

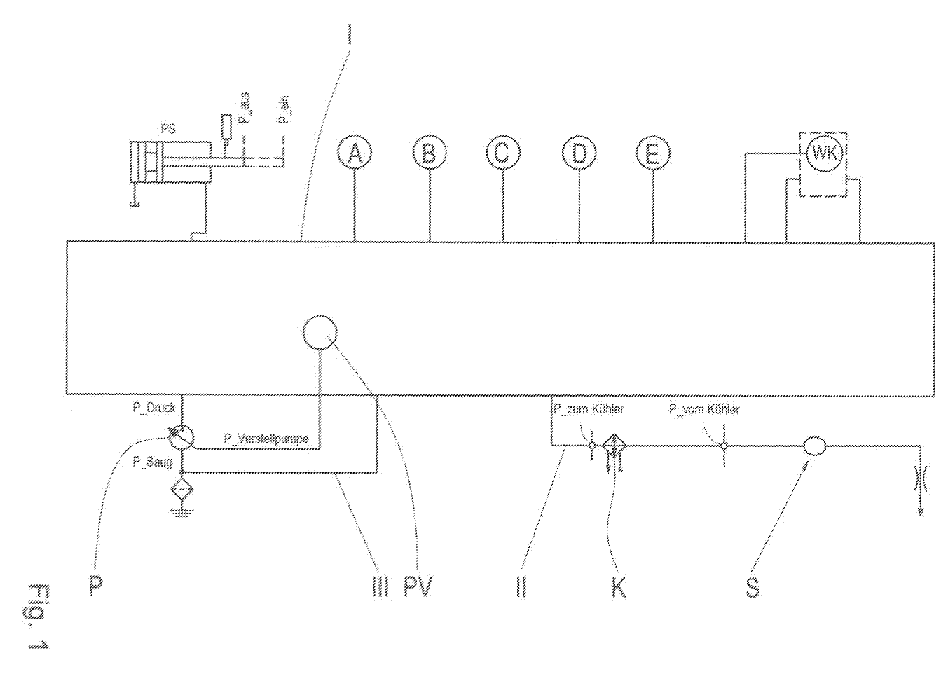

The present invention relates to a hydraulic supply system in an automatic transmission of a vehicle according to the type that is defined in more detail in the preamble of patent claim 1.

For example, the published document U.S. Pat. No. 4,693,081 discloses a control system and a method for controlling a hydraulic pump of an automatic transmission. The pump, which supplies the automatic transmission with hydraulic fluid, is controlled as a function of the output of the internal combustion engine by evaluating a throttle valve sensor, a wheel speed sensor and an engine rotational speed sensor accordingly. In essence, the output of the hydraulic pump is determined by the rotational speed of the engine.

It is also known that variable capacity pumps are used as hydraulic pumps to supply hydraulic fluid to the automatic transmission. It has been found that the known hydraulic supply systems have the drawback that it is possible to define a single operating point at best, at which the variable capacity pump is running in a sufficiently stable manner. This means that at the other operating points either too much or too little hydraulic fluid is provided. This aspect either increases the fuel consumption of the vehicle or causes the transmission components to wear faster.

The object of the present invention is to propose a hydraulic supply system of the type that is described above in the introduction and in which a precise control of the supply flow rate as a function of the respective minimum volumetric flow rate requirement or a minimum supply flow rate as a function of a measured pressure is made possible.

The above engineering object is achieved, according to the invention, by means of the features disclosed in patent claim 1 or 10, where advantageous further developments will become apparent from the respective dependent claims and the description as well as the drawings.

Thus, the object is achieved by means of a hydraulic supply system in an automatic transmission of a vehicle, said hydraulic supply system having a primary hydraulic circuit for supplying the transmission components and a secondary hydraulic circuit for lubricating and cooling the transmission components as well as at least one pump for generating a supply flow rate in the hydraulic circuits, wherein a detecting device is provided for detecting the respectively currently existing hydraulic fluid volumetric flow rate or the pressure in the secondary hydraulic circuit for adjusting a minimum hydraulic fluid volumetric flow rate or the pressure in the secondary hydraulic circuit upstream or downstream of the cooler.

This makes it possible to supply the hydraulic fluid as required, because the detecting device, provided in the cooling and lubricating circuit, prevents an oversupply or undersupply of the hydraulic fluid or oil; and, as a result, an optimization of the fuel consumption is achieved.

The other detecting device that is provided prevents only the undersupply for safety reasons; otherwise, the lubrication could not be ensured at all of the operating points in the case of a unique characteristic map design.

The detecting device may comprise at least one or more sensors, with which the volumetric flow rate or also a dependent variable, which is equivalent to the volumetric flow rate, or is defined by the volumetric flow rate, can be continuously detected. In order to detect the volumetric flow rate in a secondary hydraulic circuit, it is possible to use, for example, a volumeter or also a measuring turbine. For example, it is possible to detect, as a defined dependent variable, the pressure by means of a pressure sensor, where in this case the detected pressure value can be converted to a volumetric flow rate by means of the known throttle resistance in the secondary hydraulic circuit.

According to an advantageous further development of the invention, it can be provided that the detecting device is provided in the direction of flow downstream of a cooling device in the secondary hydraulic circuit. Conceivable are also other positions for disposing the detecting device. A pressure detecting device that is downstream of the cooling device has the advantage that the fluctuations in the amount of hydraulic fluid due to different cooler configurations or, more specifically, differently connected cooler bypasses can be prevented by varying the pressure loss in the cooling circuit, for example, by means of a cooler bypass in order to reach the operating temperatures more quickly, since they are corrected by means of the variable that is detected accordingly.

A variable capacity pump is used as the pump for supplying the hydraulic fluid. A variable capacity pump is in the following perceived as a displacement pump having a variable displacement volume. Preferably the variable capacity pump is designed as a vane cell pump. As an alternative, the variable capacity pump can be designed as an adjustable axial or radial piston pump, as a reciprocating vacuum pump, as a roller cell pump or as an adjustable gerotor pump.

However, preference is given to the use of a variable capacity pump, in which the supply volume by the rotational speed and a position of an adjusting mechanism, for example, by pivoting or moving a stroke ring, for example, at a vane cell pump in order to change the eccentricity between the rotor and the stroke ring. The adjusting mechanism can be controlled, for example, hydraulically. For example, a proportional valve for freely regulating a pressure level by means of an electric pressure actuator can be used to control the variable capacity pump. With the aid of information regarding the volumetric flow rate or pressure, detected by the hydraulic supply system in the secondary hydraulic circuit, and the proportional valve, a corresponding electric control unit can control the supply flow rate as a function of a volumetric flow rate requirement that is determined by means of a characteristic map. The characteristic map may be stored, for example, in an electronic transmission control unit (ECU) and may take into account, for example, the following variables that do not represent an exhaustive list.

First, the temperature can be taken into account in order to determine the temperature-dependent leakages and the cooling oil requirement. In addition, the rotational speed of the drive and the output can be taken into account to determine the cooling and lubricating oil requirement. Furthermore, the pressure or the torque of the engine or the turbine may be taken into account to determine the load-dependent requirement. In addition, it is possible to take into account the pressure in the converter clutch in order to determine the cooling oil requirement of the converter clutch and to take into account the fill volumetric flow rates, in order to supply the transmission components, such as, for example, in order to fill a clutch or to increase the pressure in the hydraulic circuit.

The object, on which the invention is based, is also achieved by means of a method for controlling a pump of a hydraulic supply system in an automatic transmission of a vehicle, wherein the respective currently existing hydraulic fluid volumetric flow rate in the secondary hydraulic circuit for lubricating and cooling the transmission components is detected; wherein a respective currently existing volumetric flow rate requirement is determined as a function of a characteristic map relating to the current operating range of the automatic transmission; and wherein the supply flow rate of the pump is determined; and that the supply flow rate of the pump is controlled accordingly as a function of the determined volumetric flow rate requirement.

In this way it is possible to control the amount of cooling independently of the main pressure of the pump, so that a demand-oriented supply of the hydraulic fluid or oil can be represented with this variable capacity pump control.

In this way the amount of the hydraulic fluid volumetric flow rate that is to be adjusted or regulated can be controlled dependently, as required, for each existing operating point. The variables that are to be taken into account may include, for example, the converter clutch power loss, the current transmission temperature or alternatively its profile, the transmission load with respect to the engine torque and rotational speed, the current gear, the driving program and/or the calculated clutch temperatures. In addition, it can be provided that before and/or during and/or after a shift specifically the adjustable volumetric flow rate is raised by means of an offset, in order to be able, for example, to better dissipate the clutch heat generated during shifts or to refill faster the equalizing space for the rotational pressure equalization in the case of rotating clutches, in order to enhance the shift quality in this way.

Proposed in method according to the invention and the supply system according to the invention is an electrically controlled system, in which a strictly proportional control is not used, but rather an electric control circuit having control dynamics that are significantly improved, by means of an integral and differential control component in addition to the proportional control component. Thus, significantly higher adjusting dynamics and at the same time greater control stability can be achieved. The targeted variable, i.e., the supply flow rate of the hydraulic pump, can be ideally adjusted to the operating range of the automatic transmission. Thus, with in-depth information about the system, the operating range of the controller (anti-windup against integrator windup, abrupt precontrol to the expected control value and starting from there, the beginning of the actual control, presetting of various PID parameters, depending on the operating point or the like) can be narrowed down.

In order to achieve, for example, fuel consumption advantages, it is possible to consider, for example, in the characteristic map at low temperatures that smaller amounts of coolant and lubricants are required, in that a low target supply flow rate is controlled in these operating ranges. In contrast, an insufficient supply can be avoided if, for example, at high temperatures, on the other hand, a much larger amount of cooling oil is considered during pump control.

The present invention will be explained below in more detail with reference to the drawing.

The single FIGURE of the present invention shows in schematic form a view of a hydraulic supply system according to the invention that includes a hydraulic control method.

The supply system comprises a primary hydraulic circuit I for supplying the transmission components, such as, for example, the shift elements A, B, C, D, E and a converter clutch WK as well as a parking lock device PS.

The shift elements A to E are supplied hydraulically by means of the primary hydraulic circuit I, in order to be able to engage or disengage said shift elements. Furthermore, the converter clutch and the parking lock device PS are supplied with hydraulic fluid for engagement or disengagement with the engagement pressure Pein and the disengagement pressure Paus.

Furthermore, the supply system comprises a secondary hydraulic circuit II that is supplied with hydraulic fluid in order to lubricate and cool the transmission components. In the secondary hydraulic circuit II there is a cooling device K that is supplied from the secondary hydraulic circuit II with a pressure p_zK, which is measured in the direction of flow upstream of the cooler. Then hydraulic fluid is fed from the cooling device K back again to the secondary hydraulic circuit at a pressure p_vK, which is measured downstream of the cooler.

In order to generate a supply flow rate in the hydraulic circuits I and II, a pump P is provided, to which a pressure p_Saug is fed and which delivers a pressure p_Druck to the hydraulic circuits I, II. A variable capacity pump is provided as the pump P. In order to adjust the supply flow rate at the pump P, a predetermined adjusting pressure p_Verstellpumpe is generated for the hydraulic adjustment of the pump P, and this adjusting pressure is specified, as a function of the determined volumetric flow rate requirement, by means of the electric control unit.

If the pump cannot be adjusted, for example, due to jamming in the full stroke position, the system pressure valve is used as a pressure relief valve.

In addition, there is a tertiary hydraulic circuit III in order to feed back any possible transmission-damaging excess into the intake system of the pump P.

In order to adjust a minimum supply flow rate, it is provided that a detecting device S for detecting the current hydraulic fluid volumetric flow rate in the secondary hydraulic circuit II is provided. The detecting device S comprises, for example, a sensor for detecting the pressure or the volumetric flow rate, wherein the detecting device S is disposed in the direction of flow downstream of the cooling device K in the secondary hydraulic circuit II.

Thus, a system is proposed for supplying, as required, an automatic transmission with hydraulic fluid or oil in order to hydraulically actuate the shift elements A to E and the converter clutch WK as well as to cool and lubricate the transmission and to reduce hydraulic losses by means of a pump P that can be adjusted in the supply flow rate. In this case the supply volume is adjusted to the demand at each operating point of the transmission operating range, so that the respective minimum volumetric flow rate requirement of the transmission system is achieved, where in this case said requirement may consist preferably of the volumetric flow rates of the leaks, the cooling and lubricating oil requirement as well as the cooling oil requirement of the converter clutch WK. The leaks are the leakage in the primary hydraulic circuit I, the pump leakage, and the leakage of the hydraulic control device as well as the leakage in the course of filling and applying pressure to the shift elements A to E as well as the converter clutch WK.

In this case the adjustment of the supply flow rate of the pump P is carried out by means of a control system comprising the primary hydraulic circuit I for supplying the shift elements A to E and the actuators as well as the converter clutch WK and the parking lock device PS; of the secondary hydraulic circuit II for supplying the transmission cooling and lubricating systems; and of the tertiary hydraulic circuit III. The detecting device E comprises a sensor for detecting the volumetric flow rate or a defined dependent variable in the secondary hydraulic circuit II.

In order to control the pump P, an electronic control unit is provided, with which control of the supply flow rate at the pump P is provided, as a function of the detected volumetric flow rate in the secondary hydraulic circuit II, by means of a proportional valve. The current volumetric flow rate requirement, required in the present operating range of the automatic transmission, is determined as a function of a characteristic map. The characteristic map is stored in the transmission control unit.

In the context of the method according to the present invention, the respectively current hydraulic fluid volumetric flow rate is detected in the secondary hydraulic circuit II, the current volumetric flow rate requirement is determined from the characteristic map, and the supply flow rate of the pump P is controlled. The volumetric flow rate in the secondary hydraulic circuit II can be reduced or switched off at least intermittently, when the determined volumetric flow rate requirement is lower than the volumetric flow rate detected in the secondary hydraulic circuit II. In this way the consumption can be reduced to an even greater extent.

An insufficient supply in the secondary hydraulic circuit II is detected, when the volumetric flow rate requirement, determined from the characteristic map, is higher than the volumetric flow rate detected in the secondary hydraulic circuit II. When an insufficient supply is detected, a rotational speed limiting or a torque intervention is carried out by means of the transmission control unit according to the invention. The regulation of the pressure in the secondary hydraulic circuit II is carried out, for example, by means of a directly controlled pressure regulator or a precontrolled proportional valve.

### LIST OF REFERENCE CHARACTERS

A shift element or, more specifically, clutch or brake
B shift element or, more specifically, clutch or brake
C shift element or, more specifically, clutch or brake
D shift element or, more specifically, clutch or brake
E shift element or, more specifically, clutch or brake
P pump
PS parking lock device
WK converter clutch
K cooling device
S detecting device
I primary hydraulic circuit
II secondary hydraulic circuit
III tertiary hydraulic circuit
p_aus parking lock pressure for disengagement
p_ein parking lock pressure for engagement
p_Druck pressure on the pressure side of the pump
p_Saug pressure on the suction side of the pump
p_Verstellpumpe pressure for the hydraulic adjustment of the pump
p_zum Kühler pressure in the cooling device
p_vom Kühler pressure downstream of the cooling device

1. Hydraulic supply system of an automatic transmission of a vehicle, having a primary hydraulic circuit (I) for supplying the transmission components, having a secondary hydraulic circuit (II) for lubricating and cooling the transmission components and having at least one pump (P), which is designed as a variable capacity pump with a variable supply flow rate and which is provided for generating a supply flow rate in the hydraulic circuits (I, II), characterized in that a detecting device (S) for detecting the current hydraulic fluid volumetric flow rate in the secondary hydraulic circuit (II) for adjusting a minimum supply flow rate of the pump (P) is provided.

2-12. (canceled)
